(19) United States
(12) Patent Application Publication
(10) Pub. No.: US 2011/0153404 A1
(43) Pub. Date: Jun. 23, 2011

(54) System for Permitting Contact With a Person Based on Previously Associated Indicia

(76) Inventors: Charles H. Philippe, San Diego, CA (US); Rob Richards, Encinitas, CA (US)

(21) Appl. No.: 12/760,938

(22) Filed: Apr. 15, 2010

Related U.S. Application Data
(60) Provisional application No. 61/288,177, filed on Dec. 18, 2009.

(51) Int. Cl. G06F 15/16; H04L 12/16; H04M 1/64; H04W 4/12; G06Q 30/00; G06Q 40/00; G06Q 50/00

(52) U.S. Cl. 705/14.31; 370/259; 379/88.22; 455/466; 705/34; 709/206

(57) ABSTRACT

A system for permitting communications with a group of persons living at a set of known street addresses that has a server subsystem having a computer readable memory that has the set of known street addresses recorded thereon and that is capable of storing a set of messages, each linked to one of the street addresses. A network communications and logic subsystem is capable of permitting a message sending user to send a message, indicating a street address, to the computer readable memory. Also, the server subsystem further has the capability to relay the message on to a receiving endpoint.

### RELATED APPLICATIONS

This application claims priority from provisional application No. 61/288,177, filed Dec. 18, 2009, which is hereby incorporated by reference as if fully set forth herein.

### BACKGROUND

Conventional communication systems require an initiator to have an address on hand in order to initiate contact with a recipient. Oftentimes the initiator input takes the form of an email address, phone number, or other identifier types depending on chosen communication methods. For example, a sender using a mobile device can reach a recipient via cell or landline by entering the contact's phone number on a keypad then dialing the number. Likewise, an email or text message can be sent from a sender to a recipient by use of either exact email address or phone number.

One disadvantage of such conventional methods is that the communication is very much point-to-point and requires a specific identifier, in this case a phone number, to be available to the initiator prior to establishing contact. Furthermore, the initiator is often left to make a choice between the many different contact identifiers, such as voice telephone numbers, fax telephone number(s) and email addresses which can present a difficult problem as to the best way to try to contact a recipient. The present day business card, rather than having a single telephone number, may have as many as four. The sender is confronted with a series of questions: should I email or telephone? If I telephone, should I dial the landline or the mobile number?

Another challenge of the conventional approach is that the initiator is very much dictating the timing and method of the communication which leaves the recipient with a less desirable level of control. For example, despite the many forwarding options, a recipient who does not wish to be disturbed finds himself with a set of options that either go to one extreme, disconnecting or deactivating the telephone, thereby potentially missing desired contacts, to leaving the telephone activated, thereby receiving unwanted contacts.

In some instances, an initiator might want to establish contact with a party for whom no conventional identifiers are known. For instance a restaurant owner recovers a credit card left behind by a customer and wishes to contact him, but has no means for doing so. Another example, is a motorist on the road who wishes to quickly notify a vehicle ahead of him for which a left blinker is not functioning properly, but is left with no option other than honking. Yet in another situation, a sender may wish to contact a recipient immediately but is unable to do so because the only known contact is a street address. There is therefore a need in the art of communication to enable contacts between parties when pre-existing identifiers are unknown.

### SUMMARY

In a first separate aspect, the present invention is a system for permitting communications with a group of persons living at a set of known street addresses that has a server subsystem having a computer readable memory that has the set of known street addresses recorded thereon and that is capable of storing a set of messages, each linked to one of the street addresses. A network communications and logic subsystem is capable of permitting a message sending user to send a message, indicating a street address, to the computer readable memory. The server subsystem further has the capability to relay the message on to a receiving device.

In a second separate aspect, the present invention is a system for permitting communications with a group of persons having a set of known license plate numbers that has a server subsystem having a computer readable memory that has the set of known license plate numbers recorded thereon and that is capable of storing a set of messages, each linked to one of the license plate numbers. A network communications and logic subsystem is capable of permitting a message sending user to send a message, indicating a license plate number, to the computer readable memory. The server subsystem further has capability to relay the message on to a receiving device.

In a third separate aspect, the present invention is a system for permitting communications with a group of persons having a set of known finance card numbers that has a server subsystem having a computer readable memory that has the set of known finance card numbers recorded thereon and that is capable of storing a set of messages, each linked to one of the finance card numbers. A network communications and logic subsystem is capable of permitting a message sending user to send a message, indicating a finance card number, to the computer readable memory. The server subsystem further has capability to relay the message on to a receiving device.

In a fourth separate aspect, the present invention is a system for permitting communications with a group of persons having a set of known product identification numbers that has a server subsystem having a computer readable memory that has the set of known product identification numbers recorded thereon and that is capable of storing a set of messages, each linked to one of the product identification numbers. A network communications and logic subsystem is capable of permitting a message sending user to send a message, indicating a product identification number, to the computer readable memory. The server subsystem further has capability to relay the message on to a receiving device.

### BRIEF DESCRIPTION OF THE DRAWINGS

FIG. 1 is an illustration of various types of “contact points” as that phrase is used in the present application.

FIG. 2 is an illustration of contact point assignment.

FIG. 3 is a block diagram illustrating message and contact initiation routing using the system of the present invention.

FIG. 4 is an illustration of protocol agnostic communication, according to a preferred embodiment of the present invention. FI

FIG. 5 is an illustration of different types of communications based on pre-existing indicia, such as driver's license, credit card number and street address.

FIG. 6A is an illustration of a phone multiplex interface.

FIG. 6B is an illustration of a instant message multiplex interface.

FIG. 6C is an illustration of an Email multiplex interface.

FIG. 6D is an illustration of a voice over Internet Protocol multiplex interface.

FIG. 7 is a block diagram of a system for permitting pseudonymous communications, according to the present invention.

FIG. 8 is a block diagram of communications facilitated by the use of an address messaging service.

FIG. 9 is a block diagram illustrating the use of an Email address reflecting a street address.

FIG. 10 is a block diagram illustrating the use of an Email address reflecting a license plate number.

FIG. 11 is block diagram illustrating the use of an Email address reflecting a product identifying number.

FIG. 12 is block diagram illustrating a mutually assured pseudonymous and private response channel of a messaging router.

### DETAILED DESCRIPTION OF THE PREFERRED EMBODIMENTS

A preferred embodiment of the present invention may take the form of a system for putting the recipient in charge of how communications are received, in terms of channel or mode (i.e. telephone, Email, and/or instant message) and sender class (immediate family, close friends, business associates, gym friends and others). In one embodiment of this system a server presents a website to users, over the Internet. For ease of presentation, in the following text and in the figures this website is named “pseudora.com.” Other embodiments may include other network types, for example a telephone network. Moreover, “telephone” in this application may include a voice-over-internet system, as well as a public switched telephone network (PSTN).

A user may register at pseudora.com to enter pseudonyms and to indicate how pseudonym initiated communications should be routed to the user. A user could also indicate that some messages should be routed to others, for example the user's wife. Senders need not be registered at pseudora.com but can initiate a contact through pseudora by sending an email to “pseudonym@pseudora.com,” visiting pseudora.com and entering a pseudonym, or by calling a pseudora telephone number and entering a pseudonym on the telephone keypad.

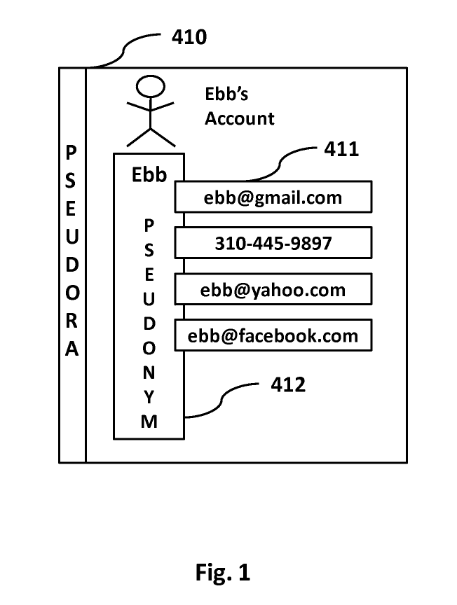

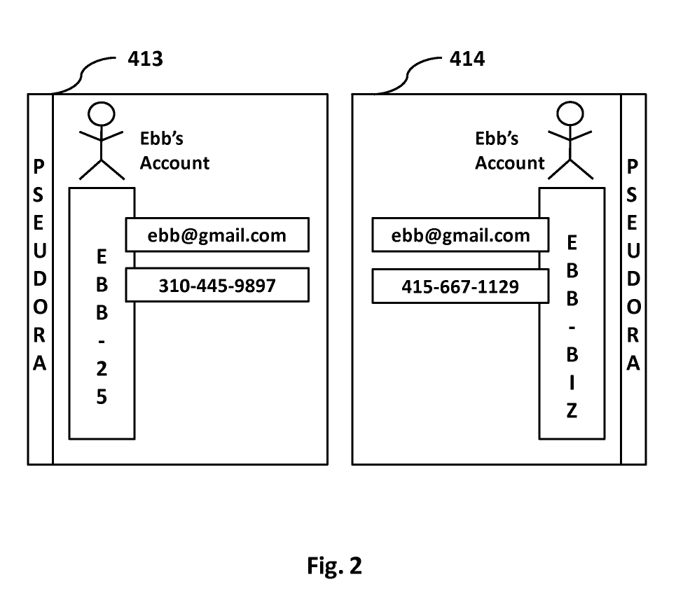

FIG. 1 shows a set of contact points 411 all assigned to the pseudonym(s) 412 of Edward B. Burns (ebb), in a pseudora.com system 410. Note that the contact points 411 include a standard email account, a telephone number and twitter and facebook accounts. Other types of contact points are possible, and the telephone number could be designated as being a text message destination or a telephone call destination. FIG. 2 illustrates a first pseudora.com pseudonym 413, which is assigned to both the ebb@gmail.com email account and the telephone number “310-445-9897”. A second pseudora.com pseudonym 414 is assigned to the same email contact point, but a different telephone number, “415-667-1129.”

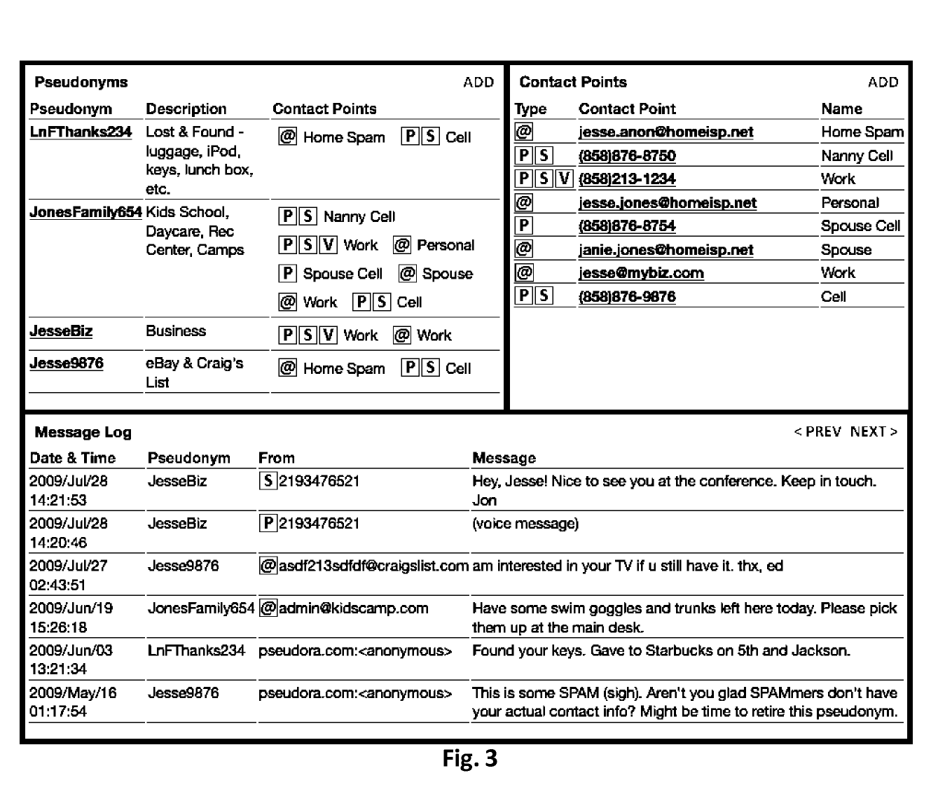

Referring to FIG. 3, examples of pseudonym assignment group are those caring for the user's children (provided with pseudonym “Jonesfamily654”), professional associates (“Jessebiz”), contacts originating on electronic commerce sites (“Jesse9876”) and those who have found some item belonging to the user that was tagged with the pseudonym “LnFThanks234”. Clearly other groups could be assigned suitable pseudonyms. Each pseudonym is assigned to one or more contact points, for example work telephone, cell phone, home email, nanny cell phone, spouse cell phone, work Email and spouse Email. Many of the telephones, including the work telephone are capable of receiving text or short message service (SMS) messages. Note that the Jonesfamily9876 pseudonym is assigned to many different contact points. There are some messages whom a recipient user would want to make sure could get through, and those concerning the user's child while at school or day care would likely fall into this category.

In one preferred embodiment provision is made for defining a family of pseudonyms all having a common root, but also including a randomly selected suffix or prefix. For example, having the root “jesse” and having a further concatenation of numbers selected at random. With this system each prospective sender could be provided with a different pseudonym, and it would be easy to delete a pseudonym, to prevent a person who has become an unwanted contactor from contacting the recipient user.

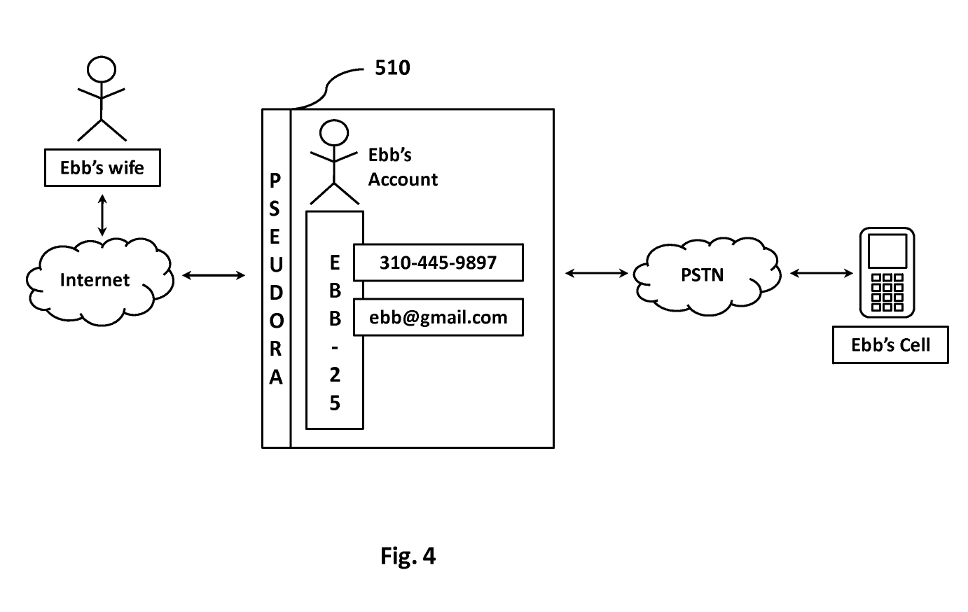

FIG. 4 illustrates the point that an Email can be sent to ebb25@pseudora.com at ebbs account 510, and result in a text message being sent over a private switched telephone network (PSTN) as a text message. The pseudora system is protocol agnostic, meaning that message need not be received in the format in which it was sent. For example, an email could be received as a voice mail message, with the words being read by an automatic system. Likewise, a voice mail message can be received as an Email, with a wav file of the voice recording, for the user to hear the exact message, and a computer generated transcript for quick review.

Preferred embodiments take advantage of the developing technology of hand held devices that include both computer access and a telephone, to also make telephone calls agnostic with Email messages. Accordingly an initiator may log into the pseudora.com site with his mobile device and enter a pseudonym. If the recipient/user is available and has indicated that contacts originating with pseudonym entered by the initiator should result in telephone contact, the contactor will be placed into a telephone contact with the recipient. In one preferred embodiment, if the sender is also a pseudora member his telephone number will be on file. First the recipient's telephone will ring, if he answers his telephone he will be notified of the telephone contact by the initiator, then the initiator's telephone will ring, and once the initiator answers both initiator and recipient will be in direct telephone communication. This method can also be used if the initiator is at a location having both an Internet connected computer and a telephone.

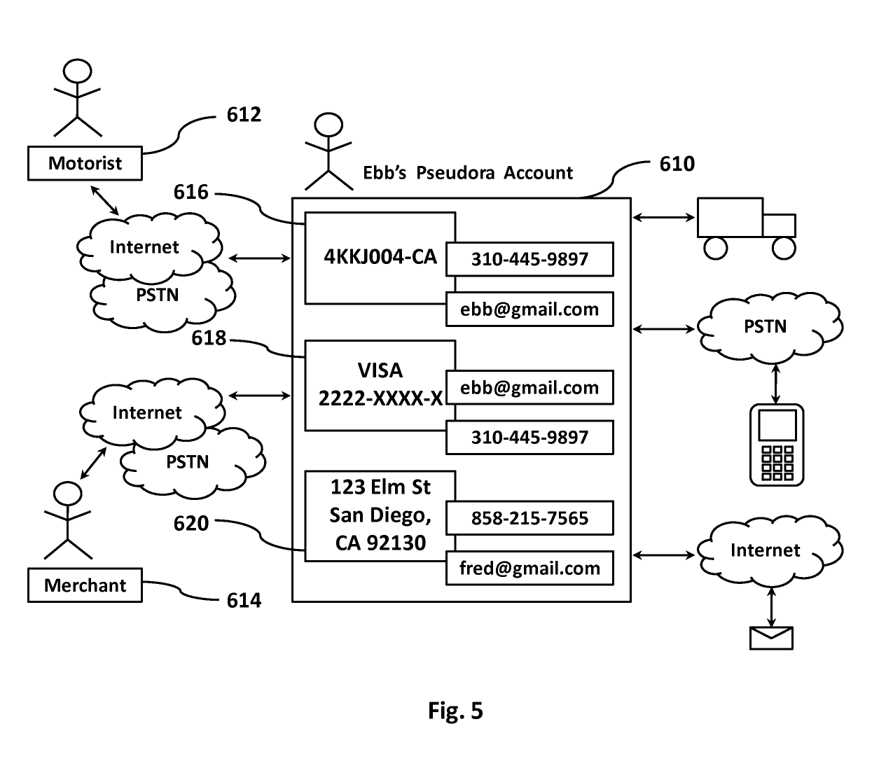

In FIG. 5 an example communication takes place from a text message sent by a motorist to a text message or Email address based on a license plate he has seen while driving. Skilled persons will recognize that many different schemes for basing text message addresses or Email addresses on license plates are possible and that any consistent system that uniquely references each license plate can be used. For example an Email sent by a motorist 612 to address 616, CA.4KKJ004.sms@Pseudora.com, results in a text message being sent to a telephone contact point registered to Ed B. Burns, who drives a car with that license plate. This system would be most useful for sending some urgent road message, such as, “your blinker is broken.” In this case the Burns family has registered the license plate number of a family car, and associated with the telephone number for Ed Burn's mobile device.

In yet another example merchant 614 sends a message, advising that a visa card has been found is sent to an Email address 618: Visa2222-xxxx-x@pseudora.com, which includes the Visa card number of the found card. The Burns family has previously specified that messages from this Email should be delivered as a text message to a cell phone.

In another example of a communication enabled by system 610, merchant 614 sends an Email to an Email address that includes a street address and zip code (123 Elm Street, San Diego, Calif. 92130) 620. Skilled persons will recognize that any convention for uniquely indicating a physical address could be used. In one preferred embodiment, merchant 612 sends an Email with the address 90456@pseudora.com resulting in an Email being forward to every Email address corresponding to a physical address in that zip code.

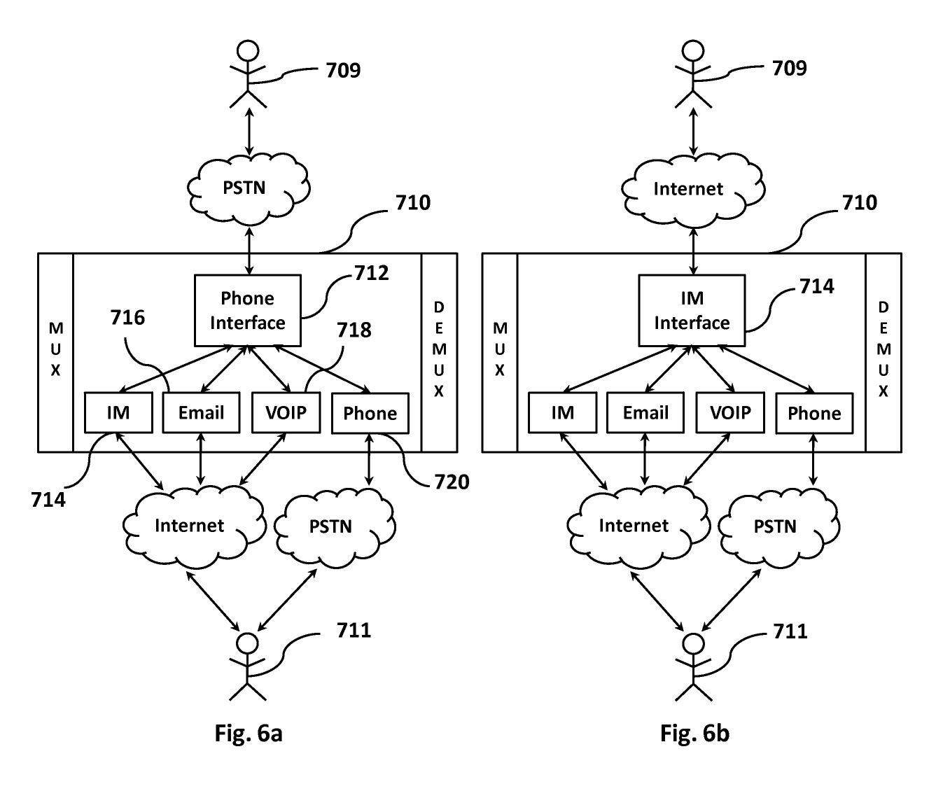

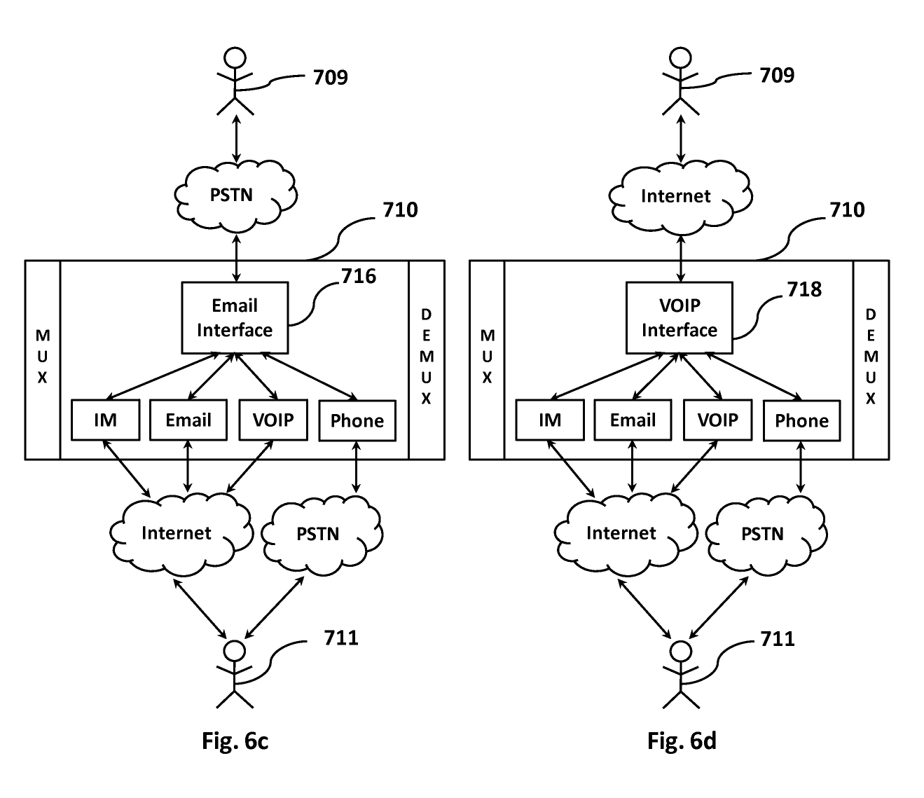

Referring to FIG. 6A, communications carried by a pseudora.com interface 710, may be carried from a communications initiator 709 to an initial responder 711 by a PSTN to a phone interface 712 where in accordance with previous instructions, it is sent by way of an instant message IM 714, Email 716, Voice over Internet Protocol (VOIP) 718 telephone connection or another PSTN 720. Messages sent from initiator 709 to responder 711 are multiplexed and messages going in the other direction are demultiplexed. Referring to FIG. 6B, a similar process can take place with respect to an instant messaging interface 714, but with the initial message being sent to interface 714 over the Internet. FIGS. 6C-6D show that the same basic process can take place with an Email Interface 718 or a VOIP interface 720.

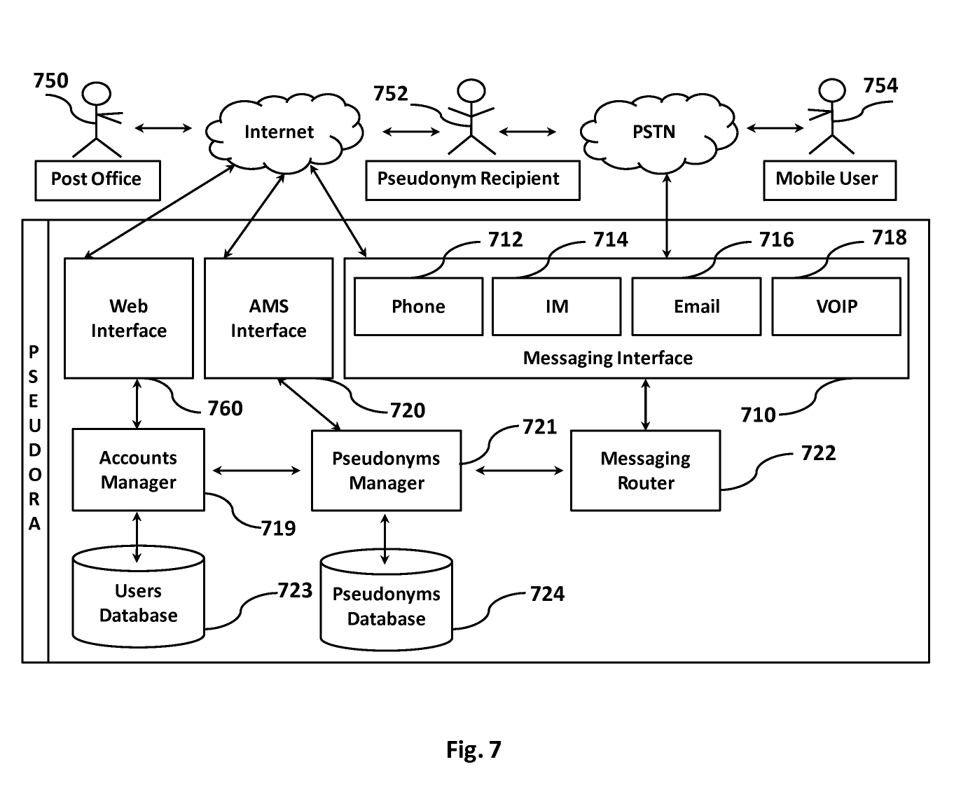

Referring to FIG. 7, a contact initiator, in this instance the post office, can send a message to a pseudonym recipient 754 by way of a secure web interface 760. The secure web interface 760 is used to verify that the sender is genuinely from the Post Office, as opposed to someone who has spotted the Pseudora.com mail address on the envelope. If the pseudonymous letter sender had previously authorized Pseudora.com to divulge his address to the post office, a response providing the recipient's address will be returned to the post office. In the event the recipient had previously indicated that he should be notified in the event of such a request, an email message can be sent to the pseudonym recipient for his authorization prior to the post office divulging his address information.

When the initiator 750 seeks to make contact by the secure web interface 760, the pseudonym manager 721, in conjunction with the pseudonym database 724 is used to look up an initial pseudonym used by initiator 750, and to instruct the messaging interface 710, by way of the messaging router 722, where to send the message. The delivery to the recipient 752 is completed by the means recipient 752 has previously specified. Likewise, a contact initiator using a mobile device 754, can start contact by way of a PSTN contact to messaging interface 710, by sending a text message to a pseudonymous text message address.

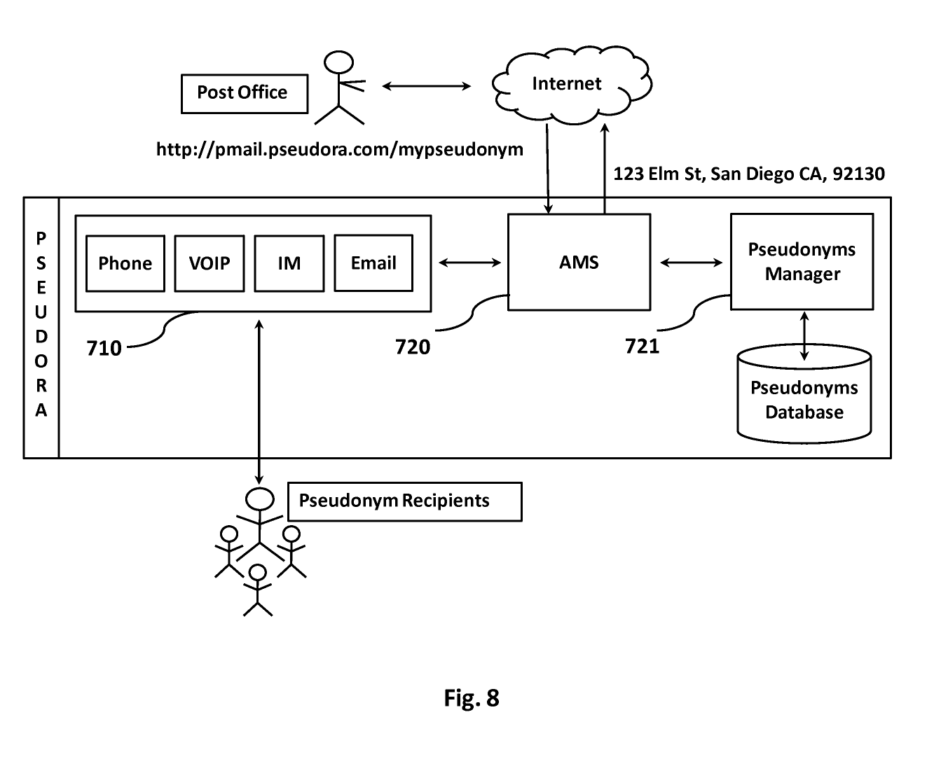

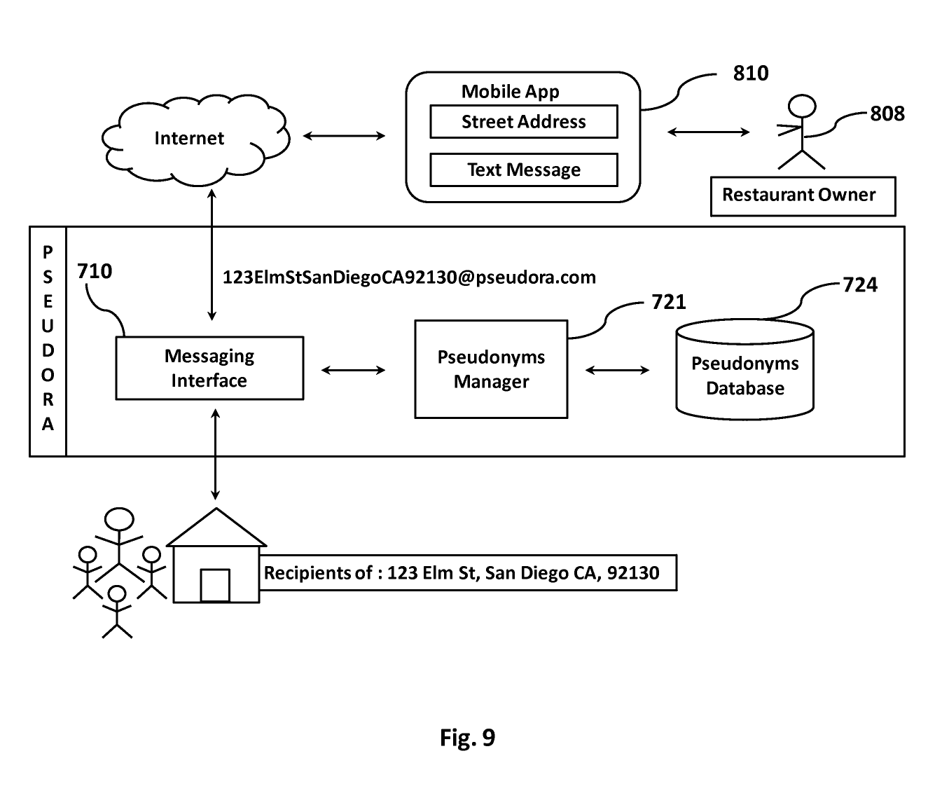

Referring to FIG. 8, in greater detail the case in which the address messaging service (AMS) 720 is used can start with a pseudonym, “mypseudonym” in this case, used in place of return address on an envelope. By accessing a webservice, for example http://pmail.pseudora.com/mypseudonym, the initiator can cause a message to be sent by any mechanism discussed above, to a person associated to “mypseudonym” advising that person that a mailing he had sent was undeliverable and that if he would like it back he would need to supply his physical address. In the example case the mail sender provides this information. In many cases, however, the mail sender could for instance respond by instructing the post office to destroy the piece of mail.

In a first example of a communication enabled by interface 710, a restaurant owner 808, using mobile device 810, sends an Email to a pseudonymous address that includes a street address and zip code. Skilled persons will recognize that any convention for uniquely indicating a physical address could be used. In one preferred embodiment, owner 808 sends an Email with the address 90456@pseudora.com resulting in an Email being forward to every Email address corresponding to a physical address in that zip code. In this example, the family of Edward B. Burns has already signed up with pseudora.com and has indicated that Emails addressed to their street address should be forwarded to the ebb@gmail.com Email address, which is periodically checked by the Email system on their family computer. Accordingly, the messaging interface 710 places the Email in the POP3 bin for the ebb@gmail.com, from whence it is retrieved by the family computer Email program. In one preferred embodiment the Burns family is paid for every Email sent to the street address Email, to encourage the family to receive Email from paying senders, such as merchant 708.

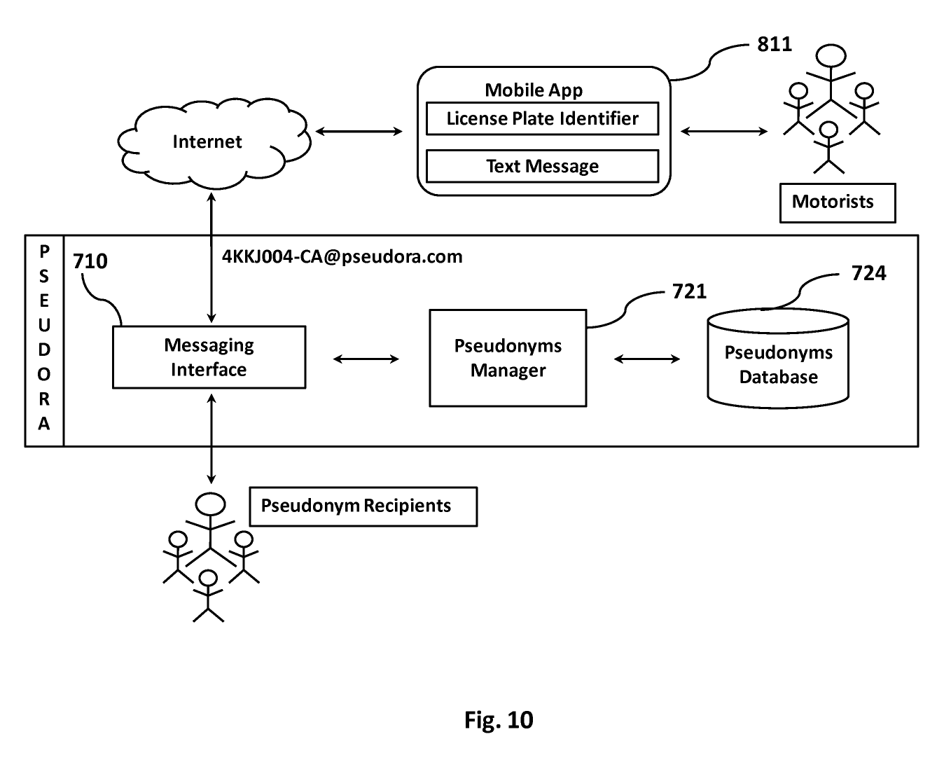

Referring to FIG. 10, motorists are enabled to send a message to the registrant of a license plate by using a application program 811 resident on a mobile device (“mobile app”). App 811 queries the user for license plate information and then generates a correctly formatted pseudonymous address, causing pseudora.com to send a message, of type specified by the recipient, to its address on file associated to that license plate number.

In a preferred embodiment emergency vehicles are enabled to communicate with vehicles blocking their way by telephone, either by tapping into the GPS system of the blocking vehicles or by observing license plates and initiating telephone calls. Because of advances in sound insulation, and instances of deafness, it may be difficult for car occupants to hear a siren. In a future system a dashboard light flashes when an incoming telephone call is received.

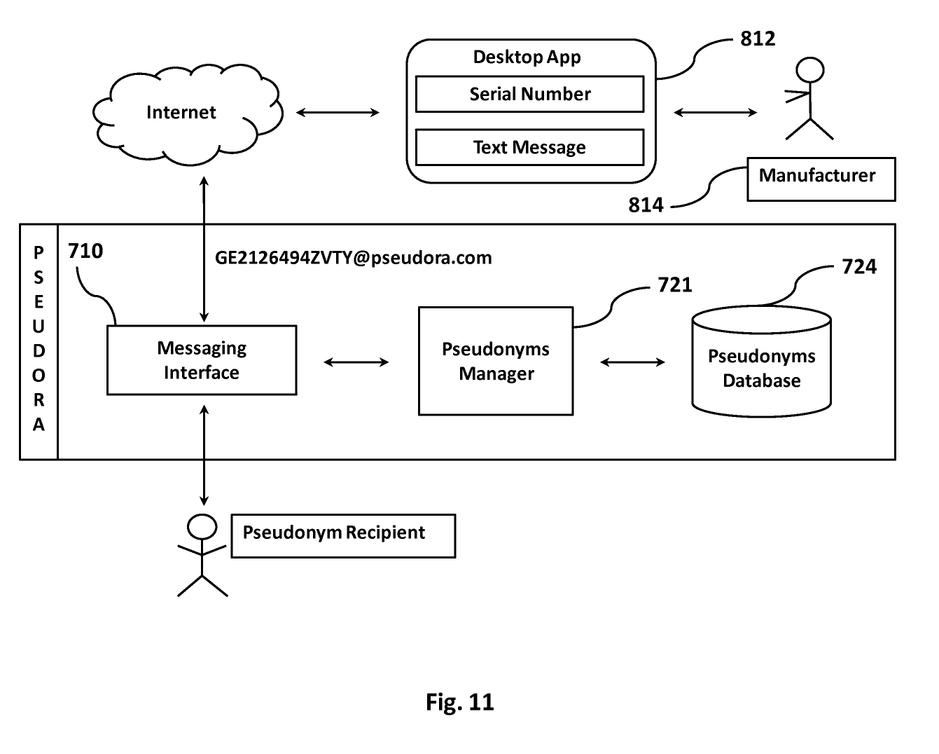

Referring to FIG. 11, in still another example a manufacturer uses a application to format an pseudonymous address based on a part number, in order send 5 year notice for ordering parts for a GE appliance. This is the sort of message that might be specified to be forwarded to the “ebb.priority2@gmail” Email POP3 account and retrieved by the family Email retriever. The ebb.priority2@gmail account is an account set up for non-urgent messages, which the user wishes to receive but to have separated from any urgent messages, so that he can check the non-urgent message file when time permits.

While a number of exemplary aspects and embodiments have been discussed above, those possessed of skill in the art will recognize certain modifications, permutations, additions and sub-combinations thereof. It is therefore intended that the following appended claims and claims hereafter introduced are interpreted to include all such modifications, permutations, additions and sub-combinations as are within their true spirit and scope.

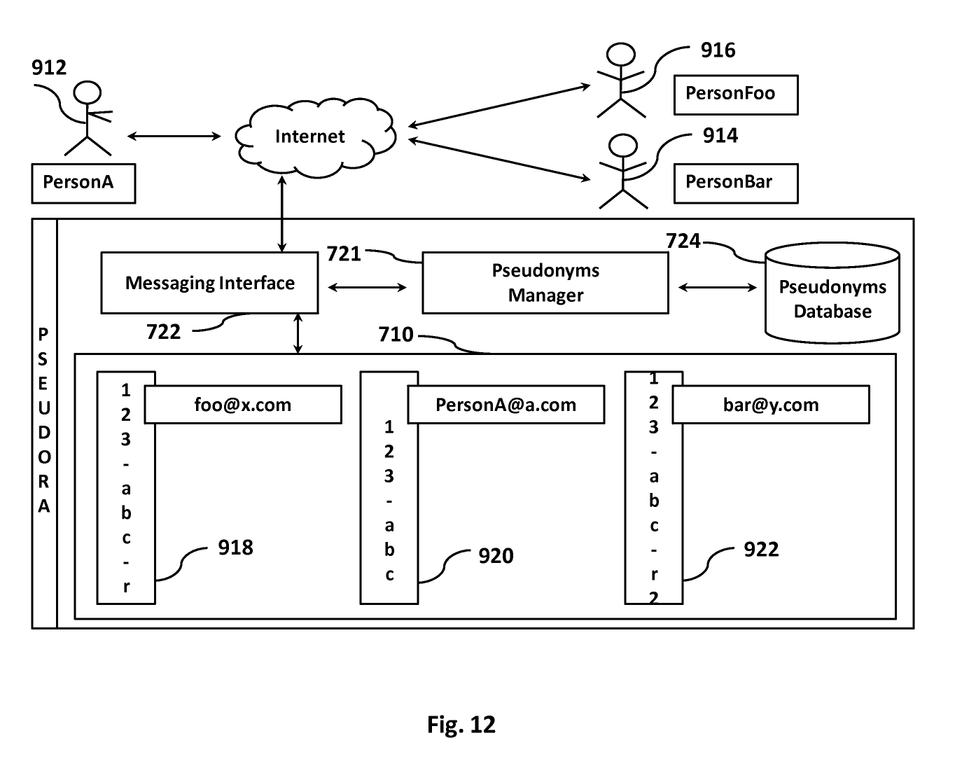

Referring to FIG. 12, under the mutually assured pseudonymity & private response channel, when a pseudonym is used to initiate communication, all parties of that communication are assured pseudonymity, and provided with a private response channel.

Example: suppose PersonFoo 916 (someone with a Pseudora account) creates pseudonym 123 associated with actual email contact point foo@x.com.
1) PersonA 912 sends an email EA to 123@pseudora.com 920, from PersonA@a.com;
2) Pseudora messaging interface 710 receives email EA and the Pseudora pseudonyms manager creates a unique response pseudonym, “123-abc,” associated with the email from PersonA@a.com, and stores it in the pseudonyms database 724;
3) Pseudora messaging router 722 re-sends the email EA as if originally addressed to foo@x.com, listing return address “123-abc@pseudora.com,” thereby hiding the identity of personA 912;
4) PersonFoo 916 reads the message EA sent to foo@x.com and sends a reply EAr to 123-abc@pseudora.com, from foo@x.com;
5) Pseudora messaging interface 710 receives message EAr and creates a unique secondary response pseudonym 918, “123-abc-r,” associated with foo@x.com;
6) Pseudora re-sends the email EAr as if originally addressed to PersonA@a.com, listing 123-abc-r@pseudora.com 918 as the return address, and thereby hiding Foo's identity;
7) PersonA replies to 123-abc-r@pseudora.com 918, and Pseudora re-sends the message as if addressed to foo@x.com, listing 123-abc@pseudora.com as the return address, once again hiding personA's identity; and
8) PersonFoo replies to 123-abc@pseudora.com, and Pseudora re-sends the message as if addressed to PersonA@a.com, from 123-abc-r@pseudora.com (repeat 7 and 8 for as long as communications continue with the automatically provided mutual pseudonymity and private response channel).

This system can also work to hide the identities of users when more than one email recipient is addressed. For instance, in the above example, if User A addresses email message EA to both foo@x.com and bar@y.com, then, in step 3, Pseudora would send two separate emails, one to foo@x.com, and a second to bar@y.com. But both with the invented return address “123-abc@pseudora.com” listed, to hide personA's identity.

If PersonBar replies with message EMr2 to 123-abc@pseudora.com, Pseudora receives EMr2, creates a further pseudonym 922 “123-abc-r2” associated with bar@y.com, and resends the message as if originally addressed to PersonA@a.com, from 123-abc-r2@pseudora.com, thereby hiding Person Bar's identity.

PersonA and PersonBar now have a private channel, separate from the private channel provided for PersonA and PersonFoo, in which both of their identities are hidden.

Note that this system also works in the case of forwards. Suppose PersonBar forwards EM to fish@z.com. PersonFish replies with message EMr3 to 123-abc@pseudora.com. Pseudora receives message EMr3, and creates a pseudonym “123-abc-r3” associated with fish@z.com, and resends the message listing return address 123-abc-r3@pseudora.com, thereby hiding all of the identities of the people involved in the forward chain. PersonA and PersonFish now have a private channel, in which both of their identities are hidden.

Although this example relates to email, similar functionality can be applied to exchanges using telephone, IM, VOIP, etc. Some of the details will be different, but the result is the same—a private channel between communicators in which each identity is hidden from the other.

1. A system for permitting communications with a group of persons living at a set of known street addresses, comprising:
(a) a server subsystem having a computer readable memory that has said set of known street addresses recorded thereon and that is capable of storing a set of messages, each linked to one of said street addresses;
(b) a network communications and logic subsystem, capable of permitting a message sending user to send a message, indicating a street address, to said computer readable memory; and
(c) wherein said server subsystem further has capability to relay said message on to a receiving endpoint.

2. The system of claim 1, wherein said computer readable memory has password information recorded for each said street address recorded thereon and wherein said network communications and logic subsystem further permits a message receiving user to enter said street address and said password and compares said entered password to said stored password for said street address, and if said passwords match, permits said user to view said messages linked to said entered street address.

3. The system of claim 2, wherein said server subsystem forwards said message as an Email.

4. The system of claim 2, wherein said server subsystem forwards said message as a voice mail message over a private switched telephone network.

5. The system of claim 2, wherein said server subsystem forwards said message as a short message service text message.

6. The system of claim 2, wherein said server subsystem forwards said message as a voice over internet protocol (VOIP) voice mail message.

7. The system of claim 1, wherein said server subsystem can relay said message by sending it as an short message system text message to a telephone number associated to said physical address.

8. The system of claim 1, wherein said message sending user is permitted to send an Email bearing an Email address that includes at least elements of said street address, and wherein said network communications and logic system enters said Email into memory and links it to said street address in said list of said set of known street addresses.

9. The system of claim 1, wherein said message sending user is permitted to send a private switched telephone network (PSTN) voice mail message bearing a PSTN number that includes at least elements of said street address, and wherein said network communications and logic system enters said voice mail message into memory and links it to said street address in said list of said set of known street addresses.

10. The system of claim 1, wherein said message sending user is permitted to send an short message service (SMS) text message bearing an SMS address that includes at least elements of said street address, and wherein said network communications and logic system enters said text message into memory and links it to said street address in said list of said set of known street addresses.

11. The system of claim 1, wherein said message sending user is permitted to send a Voice over Internet Protocol (VOIP) message bearing a VOIP address that includes at least elements of said street address, and wherein said network communications and logic system enters said VOIP message into memory and links it to said street address in said list of said set of known street addresses.

12. The system of claim 1, wherein a message sending user may alternatively enter a designator for an area, and have said message delivered to every address in said area.

13. The system of claim 12, wherein said area may be a zip code.

14. The system of claim 1, wherein a sending user may be charged a fee for sending messages using said system.

15. The system of claim 1, wherein monetary rewards are offered to entice receiving users to check for messages.

16. The system of claim 1, wherein said message sending user may send a message in which an invented return address is listed.

17. The system of claim 16, wherein said message receiving user may send a return message in which an invented return address is listed, thereby creating communications channel that is pseudonymous for both users.

18. A system for permitting communications with a group of persons having a set of known license plate numbers, comprising:
(a) a server subsystem having a computer readable memory that has said set of known license plate numbers recorded thereon and that is capable of storing a set of messages, each linked to one of said license plate numbers;
(b) a network communications and logic subsystem, capable of permitting a message sending user to send a message, indicating a license plate number, to said computer readable memory; and
(c) wherein said server subsystem further has capability to relay said message on to a receiving endpoint.

19. The system of claim 18, wherein said computer readable memory has password information recorded for each said license plate number recorded thereon and wherein said network communications and logic subsystem further permits a message receiving user to enter said street address and said password and compares said entered password to said stored password for said street address, and if said passwords match, permits said user to view said messages linked to said entered license plate number.

20. The system of claim 19, wherein said server subsystem forwards said message as an Email.

21. The system of claim 19, wherein said server subsystem can relay said message by sending it as a short message system text message to a telephone number associated to said license plate number.

22. The system of claim 19, wherein said server subsystem forwards said message as an Email.

23. The system of claim 19, wherein said server subsystem forwards said message as a private switched telephone network (PSTN) voice mail message.

24. The system of claim 19, wherein said server subsystem forwards said message as a voice over internet protocol (VOIP) message.

25. The system of claim 18, wherein said message sending user is permitted to send an Email bearing an Email address that includes at least elements of said license plate number, and wherein said network communications and logic system enters said Email into memory and links it to said license plate number in said list of said set of known license plate numberes.

26. The system of claim 18, wherein said message sending user is permitted to send a private switched telephone network (PSTN) voice mail message bearing a PSTN number that includes at least elements of said license plate number, and wherein said network communications and logic system enters said voice mail message into memory and links it to said license plate number in said list of said set of known license plate numberes.

27. The system of claim 18, wherein said message sending user is permitted to send an short message service (SMS) text message bearing an SMS address that includes at least elements of said license plate number, and wherein said network communications and logic system enters said text message into memory and links it to said license plate number in said list of said set of known license plate numberes.

28. The system of claim 18, wherein said message sending user is permitted to send a Voice over Internet Protocol (VOIP) message bearing a VOIP address that includes at least elements of said license plate number, and wherein said network communications and logic system enters said VOIP message into memory and links it to said license plate number in said list of said set of known license plate numberes.

29. The system of claim 18, wherein said message sending user is identified to said message receiving user by a license plate number based set of indicia.

30. The system of claim 18, wherein said message sending user may send a message in which an invented return address is listed.

31. The system of claim 18, wherein said message receiving user may send a return message in which an invented return address is listed, thereby creating communications channel that is pseudonymous for both users.

32. A system for permitting communications with a group of persons having a set of known finance card numbers, comprising:
(a) a server subsystem having a computer readable memory that has said set of known finance card numbers recorded thereon and that is capable of storing a set of messages, each linked to one of said finance card numbers;
(b) a network communications and logic subsystem, capable of permitting a message sending user to send a message, indicating a finance card number, to said computer readable memory; and
(c) wherein said server subsystem further has capability to relay said message on to a receiving endpoint.

33. The system of claim 32, wherein said finance card is a credit card.

34. The system of claim 32, wherein said finance card is a debit card.

35. A system for permitting communications with a group of persons having a set of known product identification numbers, comprising:
(a) a server subsystem having a computer readable memory that has said set of known product identification numbers recorded thereon and that is capable of storing a set of messages, each linked to one of said product identification numbers;
(b) a network communications and logic subsystem, capable of permitting a message sending user to send a message, indicating a product identification number, to said computer readable memory; and
(c) wherein said server subsystem further has capability to relay said message on to a receiving endpoint.
